(19) United States
(12) Patent Application Publication
(10) Pub. No.: US 2005/0086702 A1
(43) Pub. Date: Apr. 21, 2005

(54) Translation of text encoded in video signals

(76) Inventors: Christopher J. Cormack, Hillsboro, OR (US); Tony Moy, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/687,987

(22) Filed: Oct. 17, 2003

(51) Int. Cl. H04N 7/16; H04N 7/00; H04N 7/08; H04H 9/00; H04N 11/00

(52) U.S. Cl. 725/135; 348/468; 348/469

(57) ABSTRACT

A variety of different languages and formats can be displayed based on closed caption or other types of encoded text data. In one embodiment the invention includes receiving a video signal with encoded text data, decoding the encoded text data, translating the decoded text data, and combining the translated text data with a video portion of the video signal for display.

### BACKGROUND

The present invention relates to the field of presenting text with broadcast and multicast media and, in particular, to translating encoded text as it is received on a broadcast or multicast channel.

Many current broadcast and multicast video signals contain text that can be displayed on a television, or other display device. One such type of text is closed caption (CC) text. CC text typically is a transcription of the words spoken in the video, sometimes with descriptive narration for portions with few words in the soundtrack. Originally for the benefit of the hearing impaired, CC text is also used in environments where the ambient noise level (whether high or low) makes it difficult to hear the audio portion of the signal, such as bars, restaurants, airports, medical offices etc.

There are other text services that are included in video signals, including TeleText, Ceefax, and Oracle which can contain text regarding a program, electronic program guides, news, sports and emergency information and many other kinds of information. Most text services are currently encoded into the VBI (vertical blanking interval) of the video signal. However, digital video signals, including MPEG-2 (Motion Picture Experts Group) encoded signals are also structured to carry some text data with the audio and video portions of the signal.

The amount of text that can be carried in any video signal is limited by the encoding system. Systems that use the VBI have only a limited amount of capacity for carrying text. CC text must all be carried on line 21 of the VBI, so there is a limited number of characters that can be encoded into each frame. In addition, the types of characters and the formatting that can be transmitted are limited, for example, Cyrillic, Arabic and Asian characters are not supported nor are changes in size or font. TeleText has greater capabilities but is still significantly limited.

Embedded text signals are also limited by what the creator or provider of the signal decides to send. In the United States, for example, CC text is available in the English language and often also in the Spanish language. The capacity in the signal and the market demand rarely allow for any other choice. Translations of the text into Portuguese, Armenian, Hungarian and many other languages are not supported due to the lack of capacity and market demand. Translations into Chinese, Bulgarian, Thai and Hebrew cannot be provided because the encoding structure does not support the characters used in these and many other languages. TeleText and other encoded text transmission systems suffer from similar constraints.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a flow diagram of translating closed caption text according to one embodiment of the present invention;

FIG. 2 is a block diagram of a closed caption text translation system according to one embodiment of the present invention;

FIG. 3 is a block diagram of a media center suitable for implementing an embodiment of the present invention; and

FIG. 4 is a block diagram of an entertainment system suitable for use with the present invention.

### DETAILED DESCRIPTION

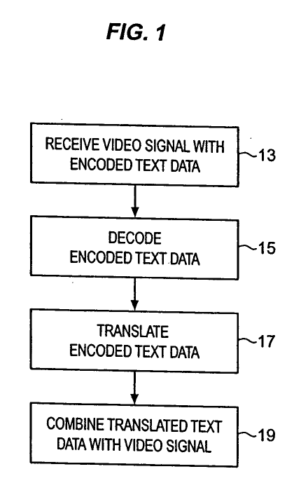

Referring to FIG. 1, closed caption or any other kind of encoded text data can be translated to any language of the user's choosing. First, a video signal with encoded text data is received in block 13. This video signal can be received from any of a variety of different sources, for example, a video tape, disk or memory player, a network connection, or a broadcast tuner. One common source of such video signals are television broadcasts through wireless and cable media. Such signals can be any type that supports encoded text. The United States has adopted NTSC (National Television Standards Committee) and ATSC (Advanced Television Systems Committee) standards, while Europe has adopted PAL (Phase Alternating Line) and SECAM (Systeme Couleur avec Memoire) standards, among others, and Japan uses still different standards.

The encoded text can correspond to many different formats used in these and other standards for transmitting encoded text. In analog video signals, encoded text is usually transmitted in raster scan lines corresponding to the VBI (vertical blanking interval) of the signal. CC (closed caption), Videotex, TeleText, Ceefax, Oracle and other standards also use lines in the VBI.

Digital signals also allot a certain portion of each packet for the transmission of text data. ATSC allocates a data rate of 9600 bps for closed captioning use. This is 10 times as much capacity as in the NTSC system and opens up the capability to offer embellished text characteristics, multi-colors, more language channels and many other features. The HD-SDI (High Definition-Serial Digital Interface) closed caption and related data is carried in three separate portions of the HD-SDI bitstream, the Picture User Data, the Program Mapping Table (PMT) and the Event Information Table (EIT). The caption text and window commands are carried in the HD-SDI Transport Channel (which in turn is carried in the Picture User Bits). The HD-SDI Caption Channel Service Directory is carried in the PMT and optionally for cable in the EIT.

There are many other text encoding systems in use and in development. The text encoding systems mentioned above are provided as examples. The invention can be applied to any encoded or concurrently transmitted text, regardless of how it is received, encoded or modulated. This can include embedded and sideband text data and supplemental text data that is provided on a different channel, frequency or stream.

Having received the video signal, the encoded text data is decoded in block 15. Decoding can be performed by conventional CC or TeleText decoders that are commercially available from a wide variety of different sources. Alternatively, the decoder can be part of a generalized digital decoder or other video processing device. For an NTSC CC text embodiment of the invention, the decoder reads the signals on line 21 of the VBI, and decodes these signals into alphanumeric characters. Different analog and video standards apply different conventions.

The result of the decoding process is typically an ordered text string that is synchronized to the video. The text can be in the same language as (e.g. CC or Oracle text) or in a different language from (e.g. subtitles) the video program. However, with some text systems, the text may not need or require any synchronization with the video. For example, if the text relates to scores of professional sports games, the scores may not have any significant relationship to the timing of the current video. Oracle, for example, is used to send a transcription of the video soundtrack, while TeleText provides general news information with no particular relationship to the video that carries it.

The decoded text data is translated in block 17. The translation can occur in different ways. In one embodiment, the text is applied to an electronic dictionary that replaces words from the original language into words of another language. Any language can be supported by providing an appropriate dictionary for the language. Using software translation systems, grammar, usage, phraseology and other nuances of translation can be accommodated to provide improved translations. Any of a variety of different translations systems may be used. The translation results in a new stream of text in another language.

The translated text can then be combined with the video signals in block 19. This combination with the video can be done by replacing the original encoded text with new text or a completely new video signal can be created that combines the text and the video. The choice of how to display the translated text will depend upon the particular application including the capabilities of the receiver and the display system.

In another embodiment, the text is not translated. The text is decoded as described above and applied to the dictionary. However, by providing a dictionary in the same language as the decoded text, the dictionary can be used to correct spelling, grammar and syntax mistakes in the encoded text. For live events and some lower budget productions, the text is entered in real-time or hurriedly and not later edited. The dictionary can then be used to correct simple errors. The corrected text can then be combined with the video signal as described above with respect to block 19 of FIG. 1.

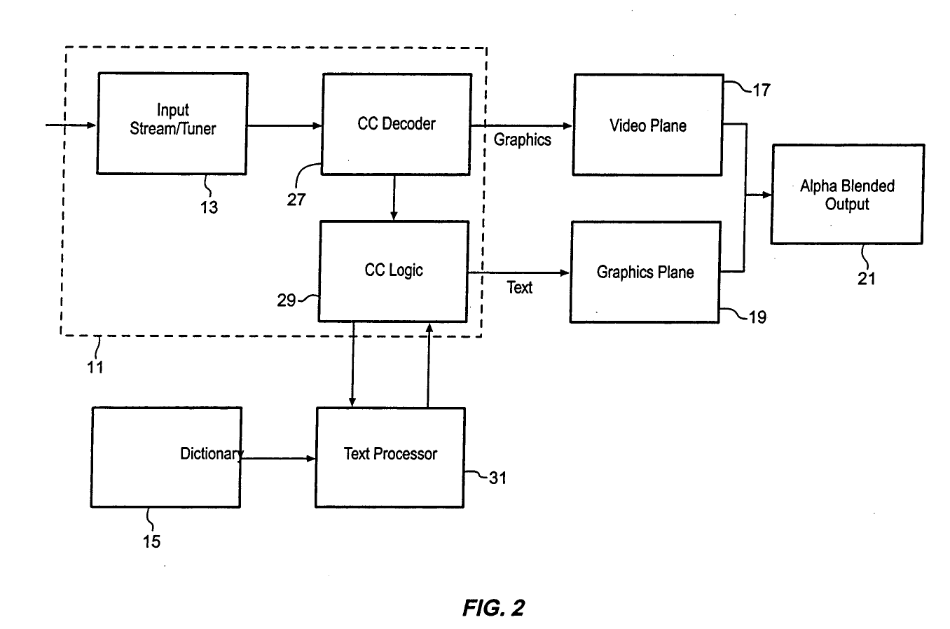

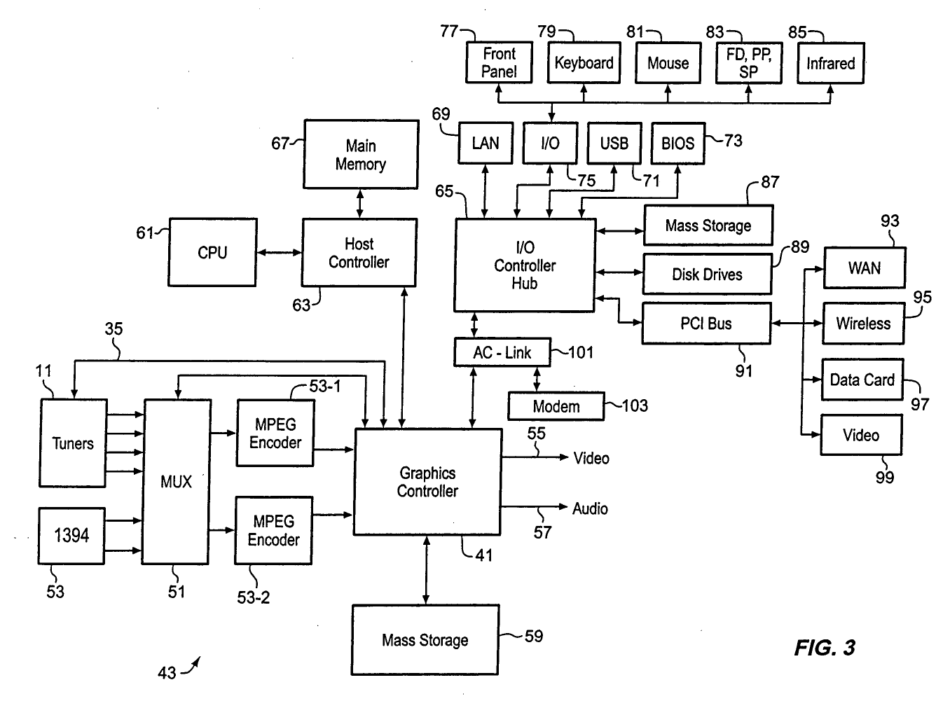

Referring to FIG. 2, a tuner system 11 capable of translating encoded text is shown. This system may be constructed on a single adapter card or printed circuit board, on a single module, or wired together from disparate locations in a larger system, one example of which is the media center shown in FIG. 3. Such a system may be a television or video display, a video or audio recorder, a discrete tuner for connection to an entertainment system or any of a variety of other devices.

The tuner system 11 of FIG. 2 has one or more analog, digital, or combination video tuners 13. The tuners may be of the same type to allow Picture-in-Picture viewing or simultaneous viewing and recording or they may be of different types to allow different kinds of sources to be received. The tuners may be for any one of a variety of different analog and digital television or video signals, whether broadcast, multicast or point-to-point. Examples include NTSC, ATSC signals, PAL (Phase Alternating Line), cable television signals under the variety of possible standards or any other type of audio or video signal.

In the present example, the tuners are coupled to a television coaxial cable, a terrestrial broadcast antenna, or a DBS (Direct Broadcast Satellite) antenna and create an MPEG-2 (Motion Picture Experts Group) encoded signal for application to other components. The exact nature of the preferred output signal will depend on the particular device. As an alternative, the tuner can include a decoder in order to produce an uncompressed digital or analog video output signal.

In the present example, the tuner output signal is applied to a closed captioning (CC) decoder 27 to extract the digital character string from the tuned signal. The extracted character string is sent to CC logic 29 which decides whether the CC text should be shown and whether it should be translated. This logic can reside in the tuner system or in some other processor in the system. Based on these decisions the text may be sent to a translation engine 31 which applies the text to a dictionary 15. The dictionary provides words, phrases, expressions or transliterations in its own language to replace the CC text. For the example of CC text, the text often contains stock phrases that relay information about what is going on in a scene. These phrases may not translate well. Accordingly a custom dictionary, specifically designed for the stock phrases of CC text can be used to enhance the understandability of the translation.

The translated CC text is sent back to the CC logic for use. The CC logic, translation engine and dictionary can all be implemented in the same hardware or in different parts of a system. The dictionary may be stored in a re-writeable memory so that different languages can be supported for different users. These communications can be performed within a single component or over a communications bus, such as I²C (Inter-IC, a type of bus designed by Phillips Semiconductors) or any other type of data bus.

The same type of translation process can also be applied to audio signals. Various standards have been proposed for supplementing broadcast audio with text and some satellite radio systems already do so. AM (Amplitude Modulation) and FM (Frequency Modulation) broadcast radio can carry RDS (Radio Data System) text including PTY (Program Type) data. The translation may be applied to this or to any other embedded or sideband data, so that the data is extracted and translated before being displayed.

Instead of or in addition to the RF (Radio Frequency) tuners described above, a composite video tuner may be used. Such a device can allow the system to receive video and audio signals from a video recorder, camera, external tuner, or any other device. This signal may then be processed through the decoder 27 and translation engine 29, in the same way as any other video or audio signals. A great variety of different connectors may be used for this tuner from coaxial cables to RCA component video, S-Video, DIN connectors, DVI (digital video interface), HDMI (High Definition Multimedia Interface), VGA (Video Graphics Adapter), and more.

As further shown in FIG. 2, the CC decoder sends the video, including any audio channel to a video plane 17 of a graphics controller or other video signal processing device. A suitable device would be the graphics controller 41 of FIG. 3, however, more or less capable components may be used. The translated CC text is sent over a graphics plane 19 to the same controller. These signals are combined in an alpha blender 21 to produce a signal that can be displayed or stored by a video device. The alpha blender uses alpha values to blend the video and graphics planes together to provide menus, EPG (Electronic Program Guide) data, and program information. The functions of the video plane, graphics plane and alpha blender can be performed by many other devices. The architecture of FIG. 2 is not necessary to the invention.

The blended output can either be the same video signal with different encoded text or it can be a video signal that includes the translated text as part of the video images. In one embodiment, the viewer is allowed to select encoded text or text embedded in the video as graphics. The graphics controller, by encoding the translated text and replacing the original text, allows all of the conventional text encoding, decoding and display technologies to control the text. For example, with an NTSC signal with CC text, a television monitor can display the translated text using the television's built-in decoder. Text display functions can be controlled by the television without any commands being sent to the tuner system or CC logic. On the other hand, including the text in the video images, avoids the need for a decoder in the display and reduces accuracy requirements for synchronizing the encoded text with specific video frames.

Alternatively, by generating a graphic display of the translated characters and combining them with the images of the video signal, the capabilities of the text data system can be enhanced. For example, the number of characters can be expanded. A translation from English into French can often require fifty percent more characters than the original English. If the encoded text is already close to its maximum capacity, then the French translation cannot be encoded into the video signal in the same way that the English text was. Additional characters, not supported by videotext, teletext, closed captioning or other text systems can be generated. For example an ATSC signal with encoded English language CC text can be translated into Chinese and displayed with traditional or modern Chinese characters. Chinese is not supported at all in CC encoding.

In addition by superimposing the text over the video, the translated text can be shown in different sizes, fonts, colors with different background effects etc. Any capability that can be programmed into the video processor 21 can be provided on the display without the need for a text decoder in the display. The viewer can be provided with menus to select the type of background (e.g. standard black, other colors, or transparent) for the text, the color of the text, the location of the text, as well as fonts and sizes. For example, when viewing video that is in a wider format than the monitor's display, the viewer may select to place the text on the upper or lower horizontal black band. This is not possible if the text is encoded back into the video signal.

FIG. 3 shows a block diagram of a media center 43 suitable for using the tuner system described above. The system of FIG. 2 can be the entire larger system. The hardware shown and described with respect to FIG. 2 is more than enough to provide an integrated or set-top tuner box with enhanced text capabilities. It receives an input at the tuner 13 and provides an output from the alpha blender 21. User interfaces through displays and user inputs can be managed and processed through the logic engine 29. The hardware of FIG. 2 can be augmented with tape, disk or memory recorders, with additional inputs and outputs or additional tuners. The dictionary 15 can be provided as a factory default or as in interchangeable memory chip or module. By providing an input/output interface, the dictionary can be updated, changed or replaced within the same or a different memory to provide any desired language or languages. The input/output interface can be direct to the dictionary or through the logic engine 29.

In FIG. 3, the capabilities of the simpler system of FIG. 2 are extensively enhanced. The tuner system 11 in FIG. 2 is coupled to a graphics controller 41 using e.g. an I²C interface as described above. In one embodiment, the video plane 17, graphics plane 19, and alpha blender 21 all reside within the graphics controller. However, other architectures are also possible. The multiple video, audio and text outputs described with respect to FIG. 2 are coupled to a multiplexer 51. Other sources may also be coupled to the multiplexer, if desired, for example an IEEE 1394 appliance 53 is shown as also being coupled to the multiplexer. Some such devices might include, tape players, disk players and MP3 players, among others. The multiplexer, under control of the graphics controller selects which of the tuner or other inputs will be connected to the rest of the media center.

The selected tuner inputs are coupled to the multiplexer outputs. These multiplexer outputs are, in the present example, routed each to respective MPEG-2 encoders 53-1, 53-2 and then to the graphics controller 41. In the case of the digital television, radio, digital cable or satellite signals, the multiplexer may route the signals around the MPEG-2 encoders or disable the encoding process as these signals are already encoded.

From the graphics controller, the video and audio signals may be output for display, storage, or recording. In one embodiment, the graphics controller contains MPEG-2 and MPEG-3 decoders as well as a video signal processor to format video and audio signals for use by the desired appliance and to combine command, control, menu, messaging and other images with the video and audio from the tuners. The graphics controller may drive the entire device or operate only for graphics functions under control of another higher level processor, as described below.

For simplicity, FIG. 3 shows only one video output and one audio output, however, the number and variety of outputs may vary greatly depending on the particular application. If the media center is to function as a tuner, then a single DVI, or component video output, together with a single digital audio output, such as an optical S/PDIF (Sony/Philips Digital Interface) output, may suffice. In the configuration shown, the media center may be used as a tuner with picture-in-picture displays on a monitor or it may be used to record one channel while showing another. If the media center is to serve more functions, then additional audio and video connections may be desired of one or more different types.

The actual connectors and formats for the video and audio connections may be of many different types and in different numbers. Some connector formats include coaxial cable, RCA composite video, S-Video, component video, DIN (Deutsche Industrie Norm) connectors, DVI (digital video interface), HDMI (High Definition Multimedia Interface), VGA (Video Graphics Adapter), and even USB and IEEE 1394. There are also several different proprietary connectors which may be preferred for particular applications. The types of connectors may be modified to suit a particular application or as different connectors become adopted.

The media center may also include a mass storage device, such as a hard disk drive, a volatile memory, a tape drive (e.g. for a VTR) or an optical drive. This may be used to store instructions for the graphics controller, to maintain an EPG (Electronic Program Guide) or to record audio or video received from the tuner system.

While the components described above are sufficient for many consumer electronics, home entertainment and home theater devices, such as tuners (terrestrial, cable, and satellite set-top boxes), VTR's, PVR's, and televisions, among others. Further functionality may be provided using some of the additional components described below. In addition, preamplifier and power amplifiers, control panels, or displays (not shown) may be coupled to the graphics controller as desired.

The media center may also include a CPU (Central Processing Unit) 61 coupled to a host controller 63 or chipset. Any number of different CPU's and chipsets may be used. In one embodiment a Mobile Intel® Celeron® processor with an Intel® 830 chipset is used, however the invention is not so limited. It offers more than sufficient processing power, connectivity and power saving modes. The host processor has a north bridge coupled to an I/O controller hub (ICH) 65, such as an Intel® FW82801 DB (ICH4), and a south bridge coupled to on-board memory 67, such as RAM (Random Access Memory). The chipset also has an interface to couple with the graphics controller 41. Note that the invention is not limited to the particular choice of processors suggested herein. In one embodiment the translation engine 31 is provided by the CPU and chipset, while the dictionary 15 is stored on a hard disk drive 87, described below.

The ICH 65 offers connectivity to a wide range of different devices. Well-established conventions and protocols may be used for these connections. The connections may include a LAN (Local Area Network) port 69, a USB hub 71, and a local BIOS (Basic Input/Output System) flash memory 73. A SIO (Super Input/Output) port 75 can provide connectivity for a front panel 77 with buttons and a display, a keyboard 79, a mouse 81, and infrared devices 85, such as IR blasters or remote control sensors. The I/O port can also support floppy disk, parallel port, and serial port connections. Alternatively, any one or more of these devices may be supported from a USB, PCI or any other type of bus.

The ICH can also provide an IDE (Integrated Device Electronics) bus for connections to disk drives 87, 89 or other large memory devices. The mass storage may include hard disk drives and optical drives. So, for example, software programs, user data, EPG data and recorded entertainment programming can be stored on a hard disk drive or other drive. In addition CD's (Compact Disc), DVD's (Digital Versatile Disc) and other storage media may be played on drives coupled to the IDE bus.

A PCI (Peripheral Component Interconnect) bus 91 is coupled to the ICH and allows a wide range of devices and ports to be coupled to the ICH. The examples in FIG. 3 include a WAN (Wide Area Network) port 93, a Wireless port 95, a data card connector 97, and a video adapter card 99. There are many more devices available for connection to a PCI port and many more possible functions. The PCI devices can allow for connections to local equipment, such as cameras, memory cards, telephones, PDA's (Personal Digital Assistant), or nearby computers. They can also allow for connection to various peripherals, such as printers, scanners, recorders, displays and more. They may also allow for wired or wireless connections to more remote equipment or any of a number of different interfaces. The remote equipment may allow for communication of programming or EPG data, for maintenance or remote control or for gaming, Internet surfing or other capabilities.

Finally, the ICH is shown with an AC-Link (Audio Codec Link) 101, a digital link that supports codecs with independent functions for audio and modem. In the audio section, microphone input and left and right audio channels are supported. In the example of FIG. 3, the AC-Link supports a modem 103 for connection to the PSTN, as well as an audio link to the graphics controller 41. The AC-Link carries any audio generated by the CPU, Host Controller or ICH to the graphics controller for integration with the audio output 57. Alternatively, an ISA (Industry Standard Architecture) bus, PCI bus or any other type connection may be used for this purpose. As can be seen from FIG. 3, there are many different ways to support the signals produced by the tuner and to control the operation of the tuners. The architecture of FIG. 3 allows for a wide range of different functions and capabilities. The particular design will depend on the particular application.

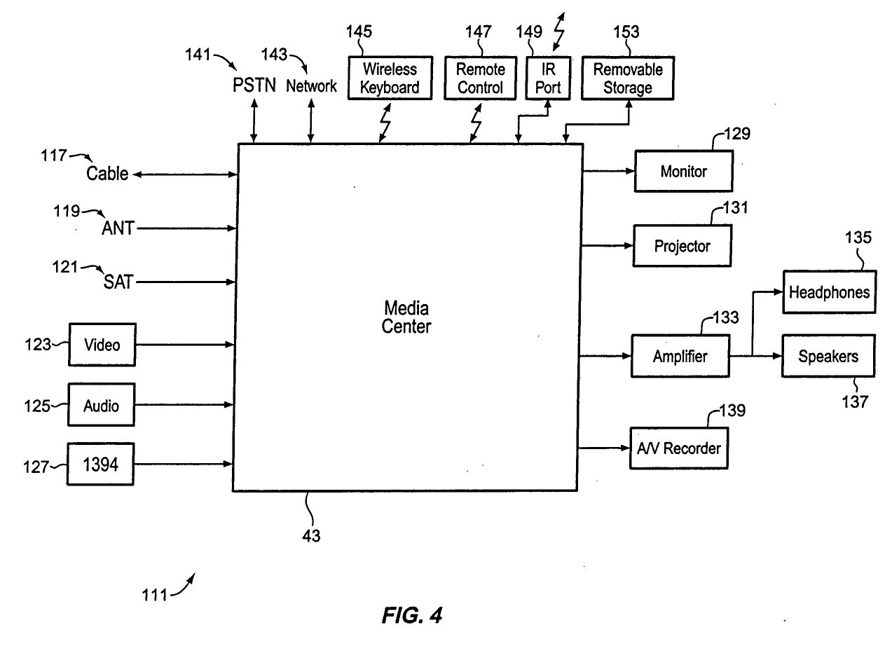

FIG. 4 shows a block diagram of an entertainment system 111 suitable for use with the media center of FIG. 3. FIG. 4 shows an entertainment system with a wide range of installed equipment. This equipment is shown as examples of many of the possibilities. The present invention may be used in a much simpler or still more complex system. The media center as described in FIG. 3, is able to support communication through WAN and LAN connections, Bluetooth, IEEE 802.11 USB, 1394, IDE, PCI, and Infrared. In addition, the tuner system receives inputs from antennas, component, and composite video and audio and IEEE 1394 devices. This provides extreme flexibility and variety in the types of devices that may be connected and operate with the media center. Other interfaces may be added or substituted for those described as new interfaces are developed and according to the particular application for the media center. Many of the connections may be removed to reduce cost. The specific devices, shown in FIG. 4 represent one example of a configuration that may be suitable for a consumer home entertainment system.

The media center 43 has several different possible inputs as described above. In the example of FIG. 4, these include a television cable 117, a broadcast antenna 119, a satellite receiver 121, a video player 123, such as a tape or disk player, an audio player 125, such as a tape, disk or memory player, and a digital device 127, connected for example by an IEEE 1394 connection.

These inputs, after processing, selection and control may be used to generate outputs for a user. The outputs may be rendered on a monitor 129, or projector 131, or any other kind of perceivable video display. The audio portion may be routed through an amplifier 133, such as an A/V receiver or a sound processing engine, to headphones 135, speakers 137 or any other type of sound generation device. The outputs may also be sent to an external recorder 139, such as a VTR, PVR, CD or DVD recorder, memory card etc.

The media center also provides connectivity to external devices through, for example a telephone port 141 and a network port 143. The user interface is provided through, for example, a keyboard 145, or a remote control 147 and the media center may communicate with other devices through its own infrared port 149. A removable storage device 153 may allow for MP3 compressed audio to be stored and played later on a portable device or for camera images to be displayed on the monitor 129.

There are many different equipment configurations for the entertainment center using the media center of FIG. 3 and many different possible choices of equipment to connect. A typical home entertainment system, using typical currently available equipment, might be as follows. As inputs, this typical home entertainment system might have a television antenna 119 and either a cable television 117 or DBS 121 input to the tuner system of the media center. A VTR or DVD recorder might be connected as an input device 123 and an output device 139. A CD player 125 and an MP3 player 127 might be added for music. Such a system might also include a wide screen high definition television 129, and a surround sound receiver 133 coupled to six or eight speakers 137. This same user system would have a small remote control 147 for the user and offer remote control 149 from the media center to the television, receiver, VTR, and CD player. An Internet connection 141 and keyboard 145 would allow for web surfing, upgrades and information downloads, while a computer network would allow for file swapping and remote control from or to a personal computer in the house.

It is to be appreciated that a lesser or more equipped entertainment system and media center than the example described above may be preferred for certain implementations. Therefore, the configuration of the entertainment system and media center will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 2, 3 and 4.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in FIGS. 2, 3, and 4, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a media center (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. An apparatus comprising:
a video receiver to receive a video signal with encoded text data;
a decoder to decode the encoded text data;
a text translator to translate the decoded text data from the language in which the text is received to a second language; and
a video processor to combine the translated text data with a video portion of the video signal for display.

2. The apparatus of claim 1, wherein the encoded text data comprises closed caption text.

3. The apparatus of claim 1, wherein the text translator further comprises a dictionary and a processor to apply the decoded text data to the dictionary to translate the text data.

4. The apparatus of claim 1, wherein the video processor generates character images of the translated text data and superimposes the character images over images of the video portion of the video signal.

5. An article comprising a machine-readable medium having stored thereon data representing instructions which, when executed by a machine, cause the machine to perform operations comprising:
receiving a video signal with encoded text data;
decoding the encoded text data;
translating the decoded text data from the language in which the text is received to a second language; and
combining the translated text data with a video portion of the video signal for display.

6. The article of claim 5, wherein translating the text data further comprises applying phrases in the decoded text data to a phrase dictionary.

7. An apparatus comprising:
a video receiver to receive a video signal with encoded text data;
a decoder to decode the encoded text data;
a text processor to process the decoded text data; and
a video processor to combine the processed text data with a video portion of the video signal for display.

8. The apparatus of claim 7, wherein the decoder reads data from a vertical blanking interval of the video signal.

9. The apparatus of claim 7, wherein the decoder comprises a digital video transport stream decoder.

10. The apparatus of claim 7, wherein the text processor further comprises a dictionary and a processor to apply the decoded text data to the dictionary to translate the text data.

11. The apparatus of claim 7, wherein the text processor further comprises a dictionary and a processor to apply the decoded text data to the dictionary to correct the text data.

12. The apparatus of claim 7, wherein the video processor generates character images of the translated text data and superimposes the character images over images of the video portion of the video signal.

13. The apparatus of claim 7, wherein the video processor encodes the translated text into text data and substitutes the encoded translated text data for the encoded text data of the received video signal.

14. A method comprising:
receiving a video signal with encoded text data;
decoding the encoded text data;
processing the decoded text data; and
combining the processed text data with a video portion of the video signal for display.

15. The method of claim 14, wherein decoding the text data comprises decoding a text signal from a vertical blanking interval of the video signal.

16. The method of claim 14, wherein decoding the text data comprises extracting a text data packet from a video transport stream of the video signal.

17. The method of claim 14, wherein processing the text data comprises applying phrases in the decoded text to a phrase dictionary.

18. The method of claim 14, wherein combining comprises generating character images of the processed text data and superimposing the character images over images of the video portion of the video signal.

19. The method of claim 14, wherein combining comprises encoding the processed text into text data and substituting the encoded translated text data for the encoded text data of the received video signal.

20. An article comprising a machine-readable medium having stored thereon data representing instructions which, when executed by a machine, cause the machine to perform operations comprising:
receiving a video signal with encoded text data;
decoding the encoded text data;
processing the decoded text data; and
combining the processed text data with a video portion of the video signal for display.

21. The article of claim 20, wherein the decoding the text data comprises extracting a text data packet from a video transport stream of the video signal.

22. The article of claim 20, wherein processing the text data further comprises applying phrases in the decoded text data to a phrase dictionary.

23. The article of claim 20, wherein combining further comprises generating character images of the translated text data and superimposing the character images over images of the video portion of the video signal.

24. The article of claim 20, wherein combining further comprises encoding the processed text data and substituting the encoded processed text data for the encoded text data of the received video signal.

25. A wireless video receiver comprising:
a video receiver to receive a wireless video signal with encoded text data;
a decoder to decode the encoded text data;
a text processor to process the decoded text data; and
a video processor to combine the processed text data with a video portion of the video signal for display.

26. The tuner of claim 25, wherein the decoder reads data from a vertical blanking interval of the video signal.

27. The tuner of claim 25, wherein the decoder comprises a digital video transport stream decoder.

28. The tuner of claim 25, wherein the text processor further comprises a dictionary and a processor to apply the decoded text data to the dictionary to obtain the processed text data.

29. The tuner of claim 25, wherein the video processor generates character images of the processed text data and superimposes the character images over images of the video portion of the video signal.

30. The tuner of claim 25, wherein the video processor encodes the processed text into text data and substitutes the encoded processed text data for the encoded text data of the received video signal.
